(19) United States
(12) Patent Application Publication
(10) Pub. No.: US 2006/0271612 A1
(43) Pub. Date: Nov. 30, 2006

(54) Method and devices for transmitting video data

(75) Inventors: Rudolf Ritter, Zollikofen (CH); Eric Lauper, Bern (CH)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: SWISSCOM MOBILE AG, Bern (CH)

(21) Appl. No.: 11/416,131

(22) Filed: May 3, 2006

(30) Foreign Application Priority Data
May 4, 2005 (EP) 05 405 336.8

(51) Int. Cl. G06F 15/00; G06F 7/00

(52) U.S. Cl. 708/203

(57) ABSTRACT

For transmitting video data from a central unit (1) via a mobile radio network (2) to a mobile terminal (3) having a display unit (32), determined is the gaze direction of a user of the display unit (32) by means of a gaze direction determination module (322) of the display unit (32). The gaze direction is transmitted by the terminal (3) via the mobile radio network (2) to the central unit (1). Based on the gaze direction, the central unit (1) determines position-dependent correlation threshold values. Moreover, the central unit (1) generates bit matrices that identify correlating picture elements having correlating picture element values, the correlating picture elements being determined dependent on the correlation threshold values. The bit matrices are transmitted together with the video data, one respective common data element, having a common picture element value, being transmitted for correlating picture elements. The display unit (32) renders picture signals based on the video data and the bit matrices. By determining the correlation threshold values depending on the gaze direction of the user, more severe conditions on the correlation of the picture element values can be applied to picture elements, located in the gazing direction of the user, than to picture elements, located outside the gaze direction. Thereby, the data volume to be transmitted can be reduced, without impairing qualitatively in a significant way for the user the subjective perception of the rendered video data.

### FIELD OF THE INVENTION

The present invention relates to a method and devices for transmitting video data, the video data comprising picture elements being positionable in a picture and having picture element values, from a central unit to a mobile terminal via a mobile radio network. Particularly, the present invention relates to a method for transmitting video data, the gaze direction of a user being determined by means of a gaze direction determination module of a display unit of the terminal, and the gaze direction being transmitted by the terminal to the central unit via the mobile radio network. Specifically, the present invention also relates to a computer-based central unit, a mobile terminal, and a computer program product suited for executing the method.

### BACKGROUND OF THE INVENTION

In patent document EP 1 186 148, described is a system for transmitting video data from a central unit to a terminal via a telecommunications network. According to EP 1 186 148, the terminal comprises a virtual retinal display device projecting directly picture signals corresponding to the video data onto the user's retina. Moreover, the display device comprises a gaze direction determination module determining the current eye position (position of pupil) by means of a so-called eye tracker as an indicator for the user's current gaze direction. For example, patent application WO 94/09472 describes such a virtual retinal display device. The central unit according to EP 1 186 148 comprises a filer module which filters the video data based on the current gaze direction, prior to their transmission, such that outer picture areas, corresponding to the video data and being projected by the virtual retinal display outside of the fovea, have a lower resolution than inner picture areas, corresponding to the video data and being projected onto the fovea. The system according to EP 1 186 148 uses the property of the human eye that a small area of the retina, being denoted as fovea and having an angle of vision of approximately 20, has the most exact vision, and thus the data volume to be transmitted can be reduced by reducing the resolution in outer areas of the picture. Particularly, for transmitting video data via mobile radio networks for mobile telephony, having a significantly lower bandwidth than fixed broadband networks, necessary is a further reduction of the data volume to be transmitted.

### SUMMARY OF THE INVENTION

It is an object of this invention to provide a method and devices for transmitting video data from a central unit via a mobile radio network to a mobile terminal, which make possible a reduction of the data volume to be transmitted.

According to the present invention, these objects are achieved particularly through the features of the independent claims. In addition, further advantageous embodiments follow from the dependent claims and the description.

According to the present invention, the above-mentioned objects are particularly achieved in that for transmitting video data from a central unit via a mobile radio network to a mobile terminal having a display unit, the video data comprising picture elements that are positionable in a picture and have picture element values, determined is a gaze direction of a user of the display unit by means of a gaze direction determination module of the display unit. The gaze direction is transmitted by the terminal to the central unit via the mobile radio network. Correlation threshold values are determined in the central unit based on the gaze direction, the correlation threshold values being position-dependent with respect to the picture. Generated in the central unit are bit matrices that identify correlating picture elements having correlating picture element values, the correlating picture elements being determined dependent on the correlation threshold values. The bit matrices are transmitted together with the video data, one respective common data element, having a common picture element value, being transmitted for correlating picture elements. The picture signals are rendered by the display unit based on the video data and the bit matrices. Transmission of the video data occurs continuously flowing, particularly, as so-called video streaming. Particularly, for positions in the picture, the central unit determines the correlation threshold values depending on a distance of a respective position in the picture to a viewing position corresponding to the gaze direction. For example, the display unit projects directly the picture signals onto at least one of the user's retina. The picture element values comprise gray values and/or color values. The advantage of determining the correlation threshold values depending on the user's gaze direction is that more severe conditions on the correlation of the picture element values can be applied to picture elements, located in the gazing direction of the user, than to picture elements, located outside the gaze direction. Thereby, it is possible to combine in a common data element picture element values of picture elements, located outside the user's gaze direction, even for large differences of the picture element values, and thus to compress the data volume of the video data to be transmitted, without impairing qualitatively in a significant way for the user the subjective perception of the rendered video data. Particularly, for virtual retinal display devices, which project picture signals directly onto the retina, the data volume can be reduced significantly, because picture elements located outside the gaze direction are projected into retinal areas that are located outside the fovea and have a lower sensitivity than the fovea.

Preferably, generating the bit matrices in the central unit includes identification of picture elements adjoining in the picture and having correlating picture element values. As shown in patent application WO 03/084205, the data volume necessary for coding picture elements can be reduced, when picture elements, adjoining in the picture and having correlating picture element values, are indicated in a bit matrix and, for the correlating picture elements, the picture element value is coded only once in a common data element. If the correlating picture elements have different values, the common picture element value is calculated as an average value of the correlating picture element values, for example.

Preferably, generating the bit matrices in the central unit includes identification of picture elements being positioned equally in (temporally) successive pictures and having correlating picture element values. As the rendering of moving pictures corresponds essentially to rendering a sequence of pictures (so-called full pictures or frames, herein referred to as pictures), the data volume needed for transmitting video data can be reduced, when picture elements, being positioned equally in successive pictures and having correlating picture element values, are indicated in a bit matrix and their picture element value is transmitted only once. The bit matrices indicate correlation of picture elements of two or more successive pictures.

In an embodiment, picture element values of picture elements, having in the picture a defined distance to a viewing position corresponding to the gaze direction, are represented by the central unit with a lower number of bits than picture element values of picture elements at the viewing position. By reducing the number of bits for the coding of picture element values for picture elements located outside the user's gaze direction, the data volume, for video data to be transmitted, can be compressed, without impairing qualitatively in a significant way for the user the subjective perception of the rendered video data.

In an embodiment, multiple adjoining picture elements, having in the picture a defined distance to a viewing position corresponding to the gaze direction, are represented by the central unit as a common picture element in a common data element. By merging adjoining picture elements located outside the user's gaze direction, the geometric extension (size) of the picture elements is increased, this means the local resolution of picture areas outside the user's gaze direction is reduced, such that the data volume, for video data to be transmitted, is compressed, without impairing qualitatively in a significant way for the user the subjective perception of the rendered video data.

In an embodiment, picture elements, having in the picture a defined distance to a viewing position corresponding to the gaze direction, are transmitted by the central unit to the mobile terminal with a reduced refresh frequency. By reducing the refresh frequency of picture elements located outside the user's gaze direction, the data volume, for video data to be transmitted, can be compressed, without impairing qualitatively in a significant way for the user the subjective perception of the rendered video data.

The present invention also relates to a computer program product comprising computer program code means for controlling one or more processors of a computer configured to transmit video data via a mobile radio network to a mobile terminal having a display unit, the video data comprising picture elements that are positionable in a picture and have picture element values, and to receive a gaze direction of a user of the display unit via the mobile radio network from the terminal. The computer program code means are configured to control the processors of the computer such that the computer determines correlation threshold values based on the gaze direction, the correlation threshold values being position-dependent with respect to the picture; generates bit matrices that identify correlating picture elements having correlating picture element values, the correlating picture elements being determined dependent on the correlation threshold values; and transmits the bit matrices together with the video data to the terminal for rendering on the display unit, one respective common data element, having a common picture element value, being transmitted for correlating picture elements. Particularly, the computer program product comprises a computer readable medium containing the computer program code means.

### BRIEF DESCRIPTION OF THE DRAWINGS

The present invention will be explained in more detail, by way of example, with reference to the drawings in which:

FIG. 1 shows a block diagram of a video data transmission system comprising a computer-based central unit that is connectable via a mobile radio network to a mobile terminal having a display unit.

FIG. 2 shows a schematic presentation of an example of multiple (temporally) successive pictures, each having multiple picture elements positionable in the picture.

FIG. 3 shows a schematic presentation of an example of multiple bit matrices that identify for pictures of FIG. 2 adjoining picture elements having correlating picture element values.

FIG. 4 shows a schematic presentation of an example of multiple bit matrices that identify for two (temporally) successive pictures of FIG. 2 adjoining picture elements being positioned equally and having correlating picture element values.

FIG. 5 shows a schematic presentation of an example of multiple bit matrices that identify for multiple (temporally) successive pictures of FIG. 2 picture elements having correlating picture element values.

FIG. 6 shows an example of a segment of a picture, the segment presenting different compression areas having different distances to a viewing position.

### DETAILED DESCRIPTION OF THE PREFERRED EMBODIMENTS

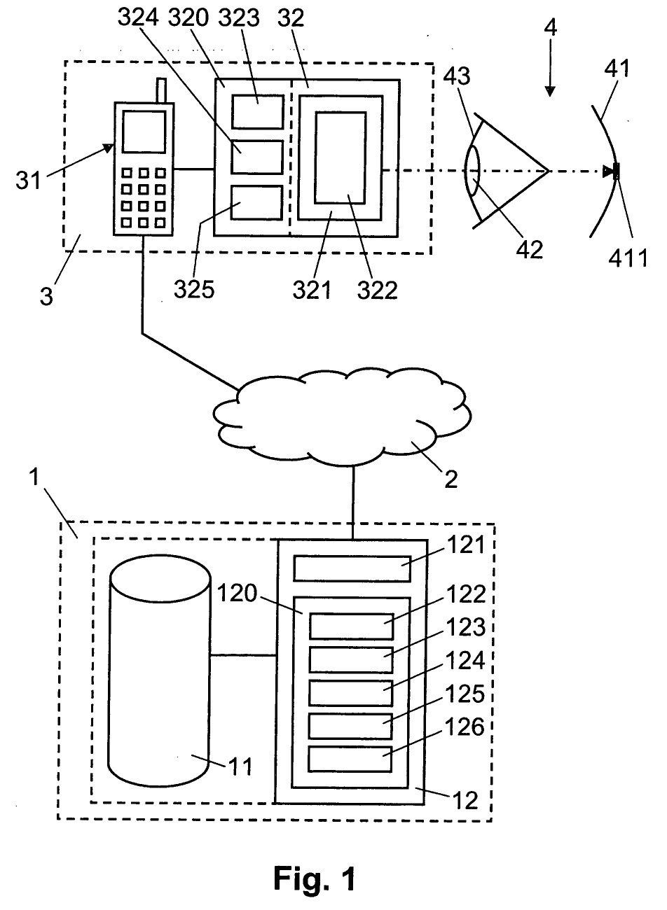

In FIG. 1, reference numeral 1 refers to a computer-based central unit comprising a video database 11, with stored video data files, as well as a computer 12 having multiple functional modules. For example, the database 11 is implemented on computer 12 or on a separate computer. The functional modules include a data compression module 120, a correlation value determination module 122, a bit matrix generating module 123, a resolution reducing module 124, a picture element value reducing module 125, as well as a refresh frequency reducing module 126. Particularly, computer 12 also includes a communication module 121 for exchanging data with communication module 31 of the mobile terminal 3 via the mobile radio network 2. Preferably, the functional modules of computer 12 are programmed software modules for controlling one or more processors of computer 12. The functional modules are stored on a computer readable medium connected fixed or removably to computer 12. One skilled in the art will understand that the functional modules of computer 12 can be implemented partly or fully by means of hardware elements.

The mobile radio network is, for example, a GSM-network (Global System for Mobile Communication), an UMTS-network (Universal Mobile Telecommunications System), a WLAN-network (Wireless Local Area Network), an UMA-network (Unlicensed Mobile Access) or another mobile radio system, e.g. a satellite-based system. One skilled in the art will understand that the proposed method can be used also via other telecommunications networks, particularly via fixed networks.

The mobile terminal 3 comprises a display unit 32 connected to the communication module 31 and implemented, for example, in the form of a set of viewing glasses, wearable on the user's head, or in another form wearable on the head. The communication module 31 and the display unit 32 are arranged, for example, in a common housing, or in separate housings and connected to each other via a wireless or contact-based communication link. If the communication module 31 is implemented with its own separate housing, the communication module 31 is implemented, for example, as a mobile radio phone, as a PDA (Personal Data Assistant), as a play station, or as a laptop computer.

As illustrated schematically in FIG. 1, the mobile terminal 3 comprises a functional block 320, implemented in the display unit 32 or in the communication module 31. The functional block 320 comprises multiple functional modules, namely a gazing direction feedback reporting module 323, a data decompression module 324, as well as a data buffer module 325. The functional modules are implemented as programmed software modules, as hardware modules, or as combination modules (hardware and software).

The display unit 32 comprises a display device 321 as well as a gaze direction determination module 322. For example, the display device 321 is implemented as a virtual retinal display device, projecting directly picture signals onto the retina 41 of the user's eye 4. The gaze direction determination module 322 comprises a so-called eye tracker that determines the position of the pupil 42 as an indicator for the user's gaze direction. A virtual retinal display having an eye tracker is described, for example, in the patent application WO 94/09472. In an embodiment, the display device 321 is implemented as an LCD display (Liquid Crystal Display), the gaze direction determination module 322 determining the gaze direction on the basis of a light reference mark projected onto the cornea 43 and the respective relative positioning of the pupil 42.

In the central unit 1, the video data are retrieved from the database 11, compressed by the data compression module 120, and transmitted to the communication module 31 of the mobile terminal 3 via the mobile radio network 2 by means of the communication module 121 of the central unit 1. The received compressed video data is decompressed by the data decompression module 324 and rendered for the user as visible picture signals by the display device 321. As described in the following paragraphs, the data compression is performed on the basis of information about the user's gaze direction. The gaze direction is determined by the gaze direction determination module 322 and transmitted to the central unit 1 via the mobile radio network 2 by the gazing direction feedback reporting module 323 using the communication module 31.

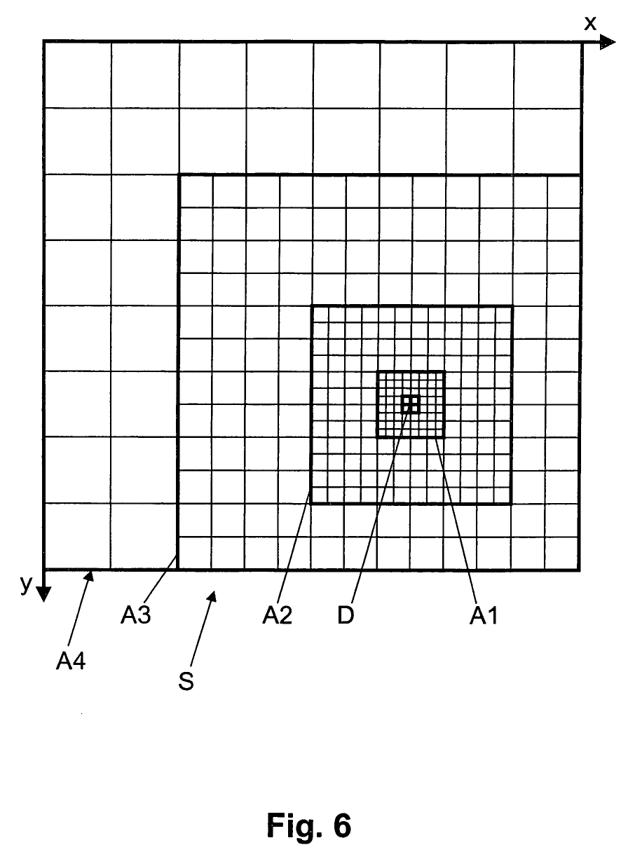

On the basis of the received current gazing direction of the user, in the data decompression module 120, the current viewing position is determined in the picture defined by the video data. FIG. 6 shows a picture segment S in which the determined viewing position is referenced with D. The viewing position D refers to a position in between individual picture elements or on exactly one picture element.

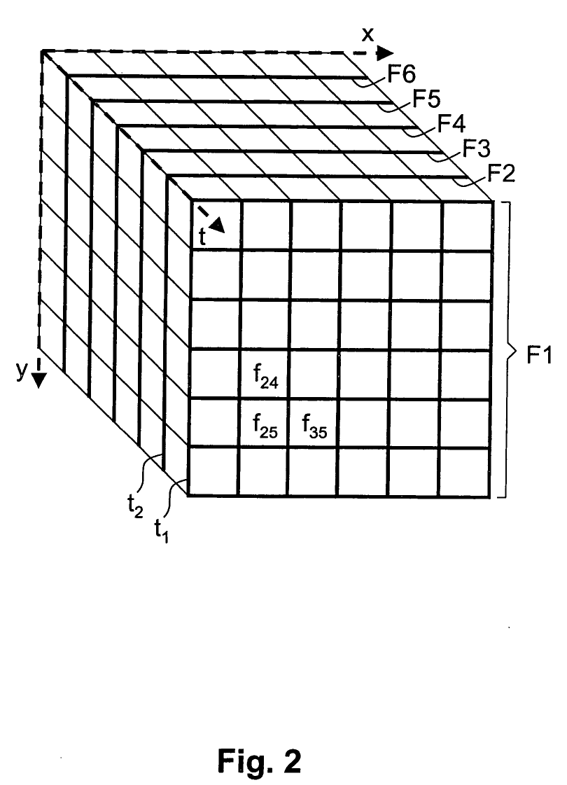

In FIGS. 2, 3, 4, 5 and 6, the reference numerals x and y refer to the coordinate axis for determining the positions of picture elements in a two-dimensional picture defined by the video data. In FIGS. 2, 3, 4 and 5, the reference numeral t refers to an inverse time axis on which objects are presented based on their time rank. This means that objects having a high value on time taxis t have a high time rank (e.g. t₁) and are to be rated temporally earlier as objects having a lower value on time axis t, which have thus a lower time rank (e.g. t₂ or t₃) and are to be rated temporally later.

In FIG. 2, presented are multiple (temporally) successive pictures F1, F2, F3, F4, F5 and F6, which are defined by the video data. The pictures F1, F2, F3, F4, F5 and F6 are each presented simplified with thirty six picture elements. In FIG. 2, only the picture elements f₂₄, f₂₅ und f₂₆ are provided explicitly with a reference numeral, the first index indicating the x-coordinate and the second index indicating the y-coordinate (of the position) of the respective picture element in picture F1, F2, F3, F4, F5, F6.

Depending on the current viewing position D, the correlation value determination module 122 determines different (position-dependent) correlation threshold values for the picture elements. Essentially, small correlation threshold values (i.e. small tolerance) are provided for picture elements, located near the current viewing position D, whereas greater correlation threshold values (i.e. greater tolerance) are provided for picture elements, located further away from the current viewing position D. For example, depending on the distance to the current viewing position D, the correlation value determination module 122 determines different compression areas A1, A2, A3, A4 having a greater correlation threshold value for greater distance to the viewing position D. The correlation threshold values are given in absolute or relative numeric values. For example, picture elements in compression area A1 are assigned a correlation threshold value of zero (zero tolerance), for the compression area A2 provided is a correlation threshold value of 10%, for the compression area A3 20%, and for the compression area A4 40%. In this example, the difference of picture element values of picture elements in compression area A4 could be up to 40% and the picture elements would still be considered correlating picture elements.

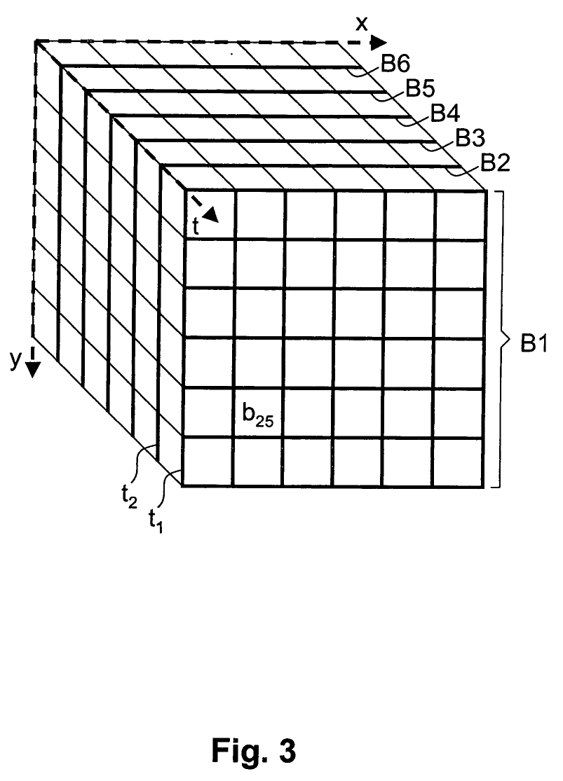

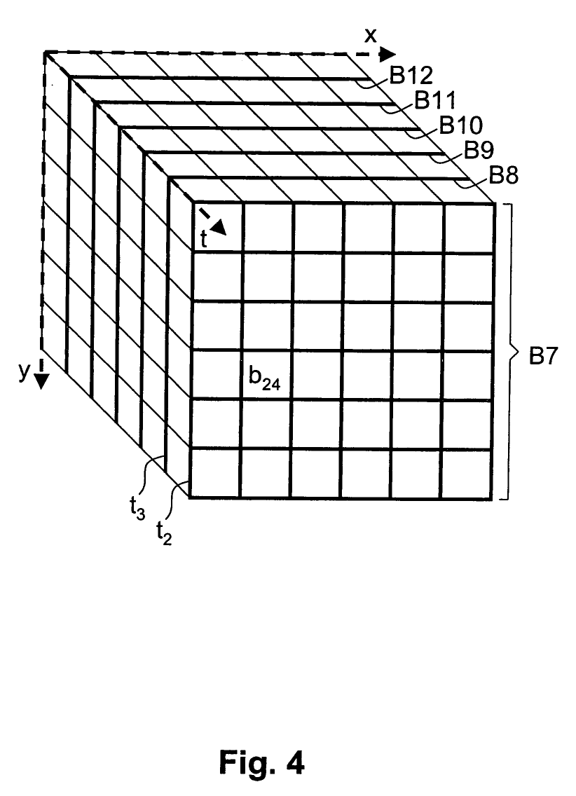

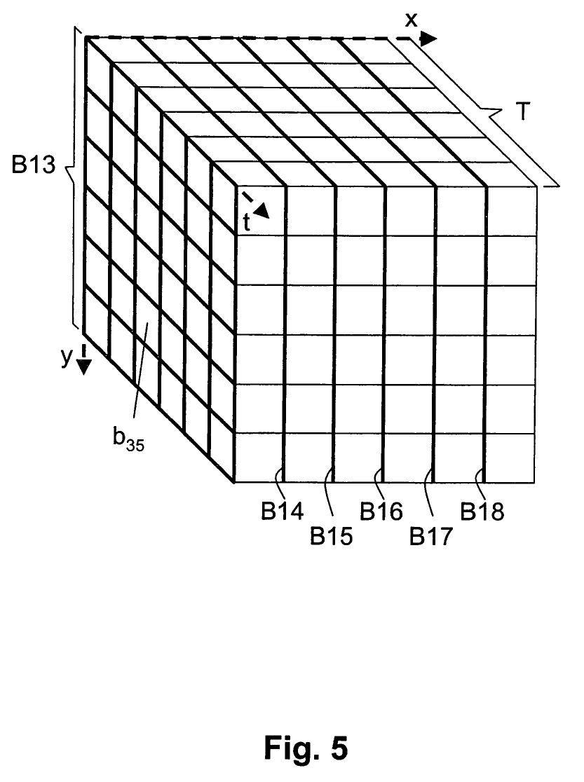

Based on the current correlation threshold values determined, the bit matrix generating module 123 generates bit matrices identifying correlating picture elements having correlating picture element values. Subsequently, with reference to FIG. 3, described is how the bit matrix-generating module 123 generates bit matrices identifying correlating picture elements, which are adjoining in a picture. Thereafter, with reference to FIGS. 4 and 5, described is how the bit matrix generating module 123 generates bit matrices identifying correlating picture elements in (temporal) successive pictures.

In FIG. 3, multiple (temporal) successive bit matrices B1, B2, B3, B4, B5 and B6 are presented. In accordance with the simplified pictures F1, F2, F3, F4, F5, F6 of FIG. 2, the bit matrices B1, B2, B3, B4, B5, B6 are presented simplified each having thirty six bits. In FIG. 3, only bit b₂₅ is provided explicitly with a reference numeral, the indices indicating the x/y-coordinates (position) of the bit in the bit matrix B1, B2, B3, B4, B5, B6 and identifying in picture F1, F2, F3, F4, F5, F6 the picture element that the bit is associated with. For example, the bit matrix B1, having time rank t₁, is assigned to picture F1, having time rank t₁, and identifies picture elements in picture F1, having correlating picture element values. For example, the bit matrices are generated according to the method described in WO 03/084205; however, for determining the correlation of neighboring picture elements, here the current position-dependent correlation threshold values are used. The correlation is determined in the horizontal direction. In the process, identified are adjoining picture elements that lie in picture F1, F2, F3, F4, F5, F6 on a straight line parallel to the x-axis, and that have correlating picture element values. Furthermore, the correlation is determined in the vertical direction. In the process, identified are adjoining picture elements that lie in picture F1, F2, F3, F4, F5, F6 on a straight line parallel to the y-axis, and that have correlating picture element values. The resulting bit matrices for the horizontal and vertical correlation are combined with each other through a logical OR operation to generate the bit matrices B1, B2, B3, B4, B5 and B6. When neighboring picture elements lie in different compression areas A1, A2, A3, A4 and have different correlation threshold values, always the lower or always the higher correlation threshold value is applied, for example. For correlating picture elements, in the compressed video data, the picture element value is coded only once in a common data element, for example as an (arithmetic) average of the correlating picture element values. An indicating bit (e.g. a bit set to “1”) in the bit matrices B1, B2, B3, B4, B5 and B6 identifies the position in the assigned picture F1, F2, F3, F4, F5, F6 where the change occurs from a first common picture element value of correlating picture elements to a next common picture element value of correlating picture elements.

In FIG. 4, presented are multiple (temporal) successive bit matrices B7, B8, B9, B10, B11 and B12. In accordance with the simplified pictures F1, F2, F3, F4, F5, F6 of FIG. 2, the bit matrices B1, B2, B3, B4, B5, B6 are presented simplified each having thirty six bits. In FIG. 4, only bit b₂₄ is provided explicitly with a reference numeral, the indices indicating the x/y-coordinates (position) of the bit in the bit matrix B7, B8, B9, B10, B11, B12 and identifying in the picture F1, F2, F3, F4, F5, F6 the picture element that the bit is associated with. For example, the bit matrix B7, having time rank t₂, is assigned to picture F2, having time rank t₂, and identifies picture elements in picture F2, having picture element values correlating each with a picture element value of an equally positioned picture element in the (temporally) preceding picture F1, having the time rank t₁ (depending on the current position-dependent correlation threshold values determined). An indicating bit (e.g. set to the value “1”) in the bit matrix B7, B8, B9, B10, B11, B12 indicates that the picture element value of the respective picture element in the new picture correlates with the picture element value of the equally positioned picture element in the preceding picture and, thus, this picture element value is not included in the compressed video data for the new picture. For example, bit b₂₄ in the bit matrix B7 identifies the picture element f₂₄ in picture F2, having a picture element value that correlates with the picture element value of picture element f₂₄ in picture F1 (depending on the current position-dependent correlation threshold value for the picture element f₂₄). Consequently, if bit b₂₄ is set in the bit matrix B7, the picture element value of picture element f₂₄ in picture F2 is not included in the video data, because it is already determined by the picture element value of the picture element f₂₄ in picture F1.

In FIG. 5, presented are multiple bit matrices B13, B14, B15, B16, B17 and B18 each relating to a defined group of picture elements in multiple (temporal) successive pictures F1, F2, F3, F4, F5, F6 within a defined time interval T. The bit matrices B13, B14, B15, B16, B17, B18 relate to picture elements lying in planes parallel to the plane of the x/y-coordinate system, a bit matrix being provided for each value of the picture in the x-direction and identifying picture elements with correlating picture element values. The bit matrices B13, B14, B15, B16, B17, B18 are presented simplified each having thirty six bits. In FIG. 5, only bit b₃₅ is provided explicitly with a reference numeral, the first index indicating the t-coordinate (time rank) and the second index indicating the y-coordinate (position) of the picture element in picture F1, F2, F3, F4, F5, F6. For example, the bit matrix B13 identifies those correlating picture elements that have an x-coordinate value of zero, lie within the time interval T, and are adjoining in the t/y-plane. The bit matrices B13, B14, B15, B16, B17 and B18 are generated as described above in the context of determining correlating picture elements among picture elements adjoining within a picture. However, for determining correlating picture elements, analyzed are neighboring picture elements in a plane running through multiple (temporal) successive pictures. In other words, in the horizontal direction, analyzed is the correlation of picture elements lying within the time interval T on a straight line parallel to the time axis t. In the vertical direction, analyzed is the correlation of picture elements lying within the time interval T on a straight line parallel to the time y-axis. Subsequently, the resulting bit matrices for the horizontal and vertical correlation are combined with each other through a logical OR operation to generate the bit matrices B13, B14, B15, B16, B17 and B18. For correlating picture elements, the picture element value is again coded only once in a data element in the compressed video data, for example as an (arithmetic) average of the correlating picture element values. An indicating bit (e.g. a bit set to “1”) in the bit matrices B13, B14, B15, B16, B17 and B18 identifies the position in the assigned picture elements of the (temporal) successive pictures F1, F2, F3, F4, F5, F6 where the change occurs from a first common picture element value of correlating picture elements to the next common picture element value of correlating picture elements.

One skilled in the art will understand that generating bit matrices based on correlation threshold values that depend on a user's gaze direction is applicable to picture element values in the form of a gray value as well as in the form of a color value, for RGB-video data (red, green, blue), each color value is treated as a separate picture element value.

For determining correlating picture elements in (temporal) successive pictures (according to FIGS. 4 or 5), other correlation threshold values can be determined and applied than the ones used for determining correlating picture elements adjoining in a picture (according to FIG. 3).

The resolution reducing module 124 encodes picture elements with varying (position-dependent) resolution, depending on the viewing position D. Essentially, a high resolution (i.e. small sizes of picture elements) is provided for picture elements near the current viewing position D, whereas a small resolution (i.e. larger sizes of picture elements) is provided for picture elements located further away from the current viewing position D. In other words, from a defined distance to the viewing position D, multiple adjoining small picture elements are represented as common picture elements in a common data element.

For encoding picture elements, the picture element value reducing module 125 determines a different (position-dependent) number of bits depending on the current viewing position D. Essentially, a greater number of bits is provided for picture element values of picture elements, located near the current viewing position D, than for picture element values of picture elements, located farther away from the current viewing position D.

Depending on the current viewing position D, the refresh frequency-reducing module 126 determines a different (position-dependent) refresh frequency for transmitting picture elements. Essentially, a greater refresh frequency is provided for picture element values of picture elements, located near the current viewing position D, than for picture element values of picture elements, located farther away from the current viewing position D.

For example, the refresh frequency for transmitting picture elements, the number of bits for encoding picture element values, and/or the resolution of picture elements are selected depending on the compression areas A1, A2, A3, A4 mentioned above with reference to FIG. 6. It shall be stated clearly here that the compression areas A1, A2, A3, A4 depicted in FIG. 6 are to be considered only as illustrative examples but must not be understood in a restrictive way. Different sizes of the compression areas A1, A2, A3, A4 can be defined for determining the correlation threshold values, the number of bits for encoding picture element values, the resolution of picture elements and/or the refresh frequency.

In the mobile terminal 3, received and stored in data buffer module 325 are the compressed video data with the bit matrices and the data elements, containing common picture element values of correlating picture elements.

Based on the associated bit matrices, the data decompression module 324 decompresses the received compressed video data into a sequence of presentable pictures, rendered for the user as picture signals by the display device 322. For example, picture elements of different sizes are mapped onto the presentable picture on the basis of size information. For assigning picture element values to picture elements positioned in (temporal) successive pictures, stored in the data buffer module 325 are at least the video data needed for determining the current presentable picture. In subsequent picture elements, correlating picture elements are determined based on the associated bit matrices, and the respective picture element values are retrieved from the stored video data. For bit matrices relating to multiple (temporal) successive pictures, the received video data are stored in data buffer module 325 at least for the time interval T.

The foregoing disclosure of the embodiments of the invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents. Specifically, in the description, the computer program code has been associated with specific software modules, one skilled in the art will understand, however, that the computer program code may be structured differently, without deviating from the scope of the invention. Furthermore, the particular order of the steps set forth in the specification should not be construed as limitations on the claims. One skilled in the art will understand that different sequences of steps are possible without deviating from the scope of the invention.

1. A method of transmitting video data from a central unit via a mobile radio network to a mobile terminal having a display unit, the video data comprising picture elements that are positionable in a picture and have picture element values, the method comprising:
determining a gaze direction of a user of the display unit by means of a gaze direction determination module of the display unit;
transmitting the gaze direction by the terminal to the central unit via the mobile radio network;
determining, in the central unit, correlation threshold values based on the gaze direction, the correlation threshold values being position-dependent with respect to the picture;
generating, in the central unit, bit matrices that identify correlating picture elements having correlating picture element values, the correlating picture elements being determined dependent on the correlation threshold values;
transmitting the bit matrices together with the video data, one respective common data element, having a common picture element value, being transmitted for correlating picture elements; and
rendering of picture signals by the display unit based on the video data and the bit matrices.

2. The method of claim 1, wherein generating the bit matrices in the central unit includes identification of picture elements adjoining in the picture and having correlating picture element values.

3. The method of claim 1, wherein generating the bit matrices in the central unit includes identification of picture elements being equally positioned in successive pictures and having correlating picture element values.

4. The method of claim 1, wherein the picture element values of picture elements, having in the picture a defined distance to a viewing position (D) corresponding to the gaze direction, are represented by the central unit with a lower number of bits than picture element values of picture elements at the viewing position (D).

5. The method of claim 1, wherein multiple adjoining picture elements, having in the picture a defined distance to a viewing position (D) corresponding to the gaze direction, are represented by the central unit as a respective common picture element in a common data element.

6. Method of claim 1, wherein picture elements, having in the picture a defined distance to a viewing position (D) corresponding to the gaze direction, are transmitted by the central unit to the mobile terminal with a reduced refresh frequency.

7. The method of claim 1, wherein the central unit determines the correlation threshold values for positions in the picture depending on a distance of a respective position in the picture to a viewing position (D) corresponding to the gaze direction, wherein the display unit projects directly the picture signals onto at least one of the user's retinas, and wherein the picture element values comprise gray values and/or color values.

8. A computer-based central unit configured to transmit video data via a mobile radio network to a mobile terminal having a display unit, the video data comprising picture elements that are positionable in a picture and have picture element values, and to receive a gaze direction of a user of the display unit via the mobile radio network from the terminal, wherein the central unit further comprises:
means for determining correlation threshold values based on the gaze direction, the correlation threshold values being position-dependent with respect to the picture;
means for generating bit matrices that identify correlating picture elements having correlating picture element values, the correlating picture elements being determined dependent on the correlation threshold values; and
means for transmitting the bit matrices together with the video data to the terminal for rendering on the display unit, for correlating picture elements, one respective common data element, having a common picture element value, being transmitted.

9. The central unit of claim 8, wherein the means for generating the bit matrices are configured to identify picture elements adjoining in the picture and having correlating picture element values.

10. The central unit of claim 8, wherein the means for generating the bit matrices are configured to identify picture elements being equally positioned in successive pictures and having correlating picture element values.

11. The central unit of claim 8, further comprising means for representing with a lower number of bits the picture element values of picture elements, having in the picture a defined distance to a viewing position (D) corresponding to the gaze direction, than picture element values of picture elements at the viewing position (D).

12. The central unit of claim 8, further comprising means for representing multiple adjoining picture elements, having in the picture a defined distance to a viewing position (D) corresponding to the gaze direction, as a common picture element in one respective common data element.

13. The central unit of claim 8, further comprising means for transmitting to the mobile terminal with a reduced refresh frequency picture element values of picture elements, having in the picture a defined distance to a viewing position (D) corresponding to the gaze direction.

14. The central unit of claim 8, wherein the means for determining the correlation threshold values are configured to determine the correlation threshold values for positions in the picture depending on a distance of a respective position in the picture to a viewing position (D) corresponding to the gaze direction, and wherein the picture element values comprise gray values and/or color values.

15. A mobile device having a display unit and being configured to receive video data via a mobile radio network from a central unit, the video data comprising picture elements that are positionable in a picture and have picture element values, the mobile device comprising a gaze direction module for determining a gaze direction of a user of the display unit, and means for transmitting the gaze direction to the central unit via the mobile radio network, wherein the mobile device further comprises:
means for receiving from the central unit, together with the video data, bit matrices that identify correlating picture elements having correlating picture element values, the correlating picture elements being determined dependent on the correlation threshold values, for correlating picture elements, the video data comprising one respective common data element, having a common picture element value; and
means for rendering of picture signals on the display unit based on the video data and the bit matrices.

16. The mobile device of claim 15, further comprising means for assigning a picture element value, contained in a common picture element, to adjoining picture elements in the picture based on the bit matrix assigned to the picture.

17. The mobile device of claim 15, further comprising means for assigning a picture element value, contained in a common picture element, to equal positioned picture elements in successive pictures based on the bit matrix assigned to the picture.

18. The mobile device of claim 15, wherein the display unit is configured to project directly the picture signals onto at least one of the user's retina, and wherein the picture element values comprise gray values and/or color values.

19. Computer program product comprising computer program code means for controlling a computer configured to transmit video data via a mobile radio network to a mobile terminal having a display unit, the video data comprising picture elements that are positionable in a picture and have picture element values, and to receive a gaze direction of a user of the display unit via the mobile radio network from the terminal, such that the computer:
determines correlation threshold values based on the gaze direction, the correlation threshold values being position-dependent with respect to the picture;
generates bit matrices that identify correlating picture elements having correlating picture element values, the correlating picture elements being determined dependent on the correlation threshold values; and
transmits the bit matrices together with the video data to the terminal for rendering on the display unit, one respective common data element, having a common picture element value, being transmitted for correlating picture elements.
